(19) United States
(12) Patent Application Publication
(10) Pub. No.: US 2006/0136290 A1
(43) Pub. Date: Jun. 22, 2006

(54) Method for administrating and analyzing work place monitoring data

(75) Inventor: Jer-Pei Fong, Taichung City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Chutung (TW)

(21) Appl. No.: 11/260,462

(22) Filed: Oct. 28, 2005

(30) Foreign Application Priority Data
Dec. 21, 2004 (TW) 093139894

(51) Int. Cl. G06F 11/34

(52) U.S. Cl. 705/11

(57) ABSTRACT

A method for administrating and analyzing work place monitoring data through a microprocessor is disclosed. The method can store the input data directly, automatically calculate the input data and the historical data through a selected statistical model and output a readable report in a worksheet form (e.g. in an EXCEL form). The method can also provide integrated reports of description or charts based on various statistical models. Through the method, the management of data and advanced statistical analysis can be integrated.

### BACKGROUND OF THE INVENTION

1. Field of the Invention

The present invention relates to a method for administrating and analyzing work place monitoring data, and more particularly, the present invention is adapted for examining the exposure monitoring data in an occupational environment.

2. Description of Related Art

It is common that general business units are required to monitor the work place exposure of the work place by Occupational Safety and Health Act. However, the monitoring data obtained after processing a sampling analysis are usually recorded in different formats or only recorded by paper documents thereby resulting in the analyzed statistic data to be in a chaotic situation without being systematically collected. Also, no further statistical analysis and application for occupational exposure monitoring data under different work place can be applied.

Moreover, generally when collecting exposure monitoring data, different selected statistical models are applied due to the limitation of different group requirements. Therefore, the requirement for statistical analysis cannot be fully satisfied because of different group requirements. As a result, an overall conclusion of the monitoring data analysis report and statistical analysis cannot be obtained. Consequently, the conventional data management analysis system is unable to integrate the data format and adapt to various groups, and with the disadvantage of lack of selected statistical models.

Therefore, it is desirable to provide a method for administrating and analyzing work place monitoring data to mitigate and/or obviate the aforementioned problems.

### SUMMARY OF THE INVENTION

The object of the present invention is to provide a method for administrating and analyzing work place monitoring data, so as to efficiently integrate work place monitoring data information over the years, and to analyze exposure information in accordance with different groups for generating an overall measurement data analysis report and thereby helping the user to realize the real exposure profile in the different work place.

To achieve the object, the method for administrating and analyzing work place monitoring data comprises the steps of: (A) receiving at least one monitoring data, wherein the at least one monitoring data is obtained from an work place monitoring measurement result; (B) comparing a data format of the at least one monitoring data with a normalized format and outputting an error text message if the comparison result is not matched, otherwise recording the data format in a first database; (C) receiving at least one filter instruction; (D) retrieving the monitoring data from the first database according to the at least one filter instruction and returning at least one monitoring data for further comparison; (E) retrieving at least one corresponding field data from a second database; (F) transmitting the returned monitoring data and the corresponding field data of the second database to a statistical model so as to generate a readable report; and (G) outputting the readable report to word processing software for display.

In the above method, the at least one monitoring data comprises at least a species name, an analysis classification, a sample number, a sampling time, a sampling density and a unit.

In the above method, the at least one monitoring is recorded by word processing software.

In step (B) of the above method, the error text message is recorded with the error data of the monitoring data and cannot be recorded in the first database.

In the above method, the second database is an occupational exposure database.

In step (D) of the above method, the filter instruction is the data content to be analyzed.

In step (E) of the above method, the occupational exposure data is a sampling information and analysis result of the monitoring data.

In the above method, the first database is recorded with at least a unit name, a monitoring date, a work name, a similar exposure group, a chemical name, and a chemical unit.

In the above method, the selected statistical model comprises a statistical model, an occupational exposure limit (OEL) classification model, and a graphic model.

In the above method, the selected statistical model further comprises a statistical method of descriptive statistics, a statistical method of goodness of fit test, and a statistical method of small sample.

Other objects, advantages, and novel features of the invention will become more apparent from the following detailed description when taken in conjunction with the accompanying drawings.

### BRIEF DESCRIPTION OF THE DRAWINGS

FIG. 1 illustrates a system structure of administrating and analyzing work place monitoring data of one preferred embodiment according to the present invention; and

FIG. 2 illustrates a flowchart of administrating and analyzing work place monitoring data of the preferred embodiment according to the present invention.

### DETAILED DESCRIPTION OF THE PREFERRED EMBODIMENT

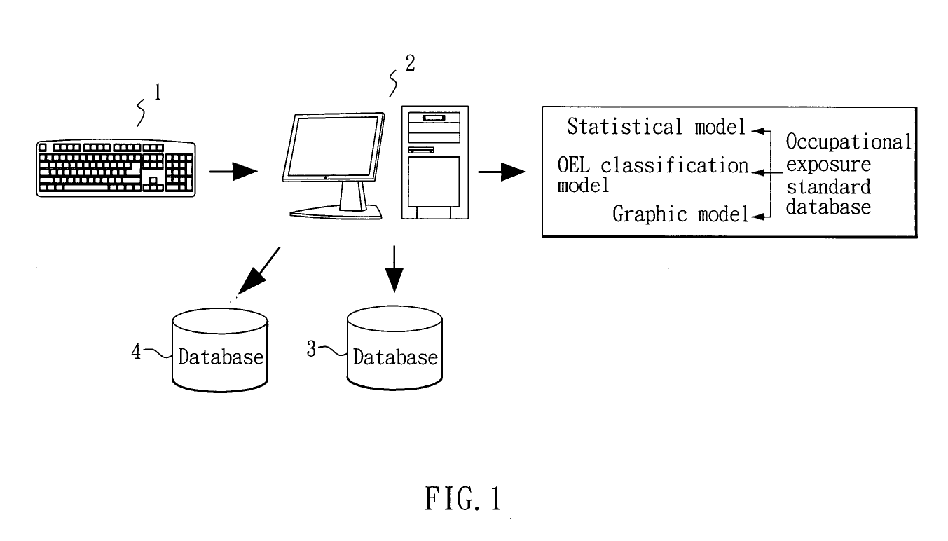

Please refer to FIG. 1. FIG. 1 illustrates a system structure of administrating and analyzing work place monitoring data of one preferred embodiment according to the present invention. The system structure of this embodiment comprises a keyboard 1, a management analysis system 2, a first database 3, and a second database 4. In this embodiment, the first database 3 is recorded with the measured work place monitoring data information over the years, including fields of at least a species name, an analysis classification, a sample number, a sampling time, a sampling density and a unit. Further, the second database 4 is an occupational exposure database recorded with the sampling information and analysis result of each occupational exposure measurement. Additionally, Chemical Abstracts Service (CAS) numbers are regarded as the only index for establishing the correlation with the occupational exposure standard value database so as to accomplish the comparison with standard values. The management analysis system 2 is mainly focused on providing the statistical analysis function. In this embodiment, the management analysis system 2 has a selected statistical model which can be divided into the following models according to different functionalities: a statistical model, a classification graphic model, and an occupational exposure limit (OEL) control model. In the embodiment, the management analysis system 2 is connected with the first database 3 and the second database 4, such that the administrator can import those measured monitoring data over the years for processing data addition, deletion or modification via the management analysis system 2. Then, the monitoring data analysis required to be statistical analysis in combination with the monitoring data are inputted into the selected statistical model for processing the statistical analysis procedure so as to generate a readable report. In the embodiment, the selected statistical model performs a complete analysis procedure to the work place monitoring data, and provides the improvement reference with simple charts and diagrams for each business unit. The management analysis system may also export the readable report to word processing software for display, wherein the word processing software is preferably Microsoft EXCEL™ in this embodiment.

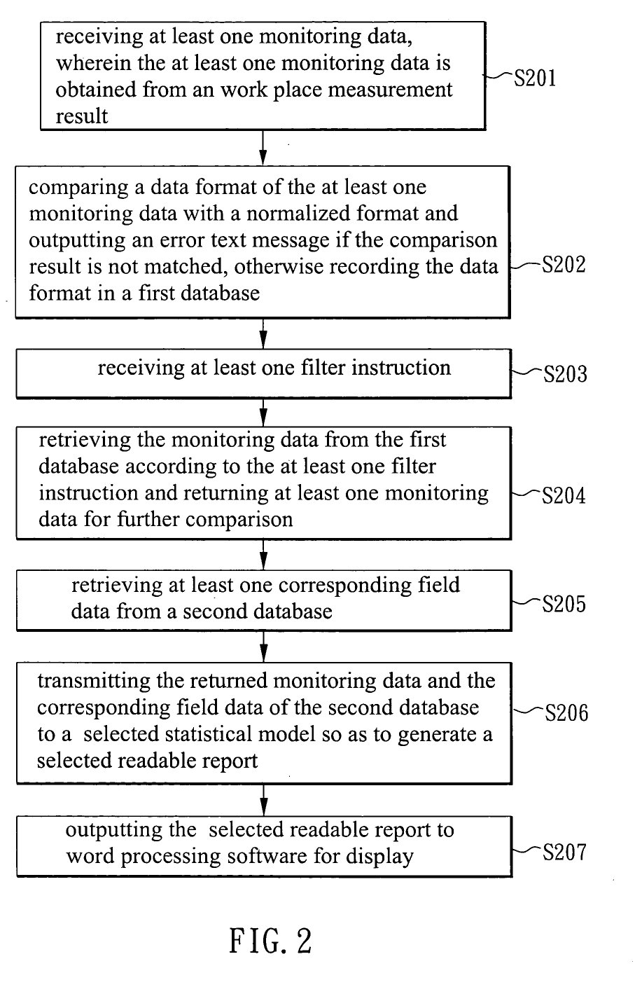

With reference to FIG. 2, FIG. 2 illustrates a flowchart of administrating and analyzing work place monitoring data of the preferred embodiment according to the present invention. The method includes the following steps:

First of all, at least one monitoring data is received, wherein the at least one monitoring data is obtained from a work place monitoring measurement result (step S201). After the inspector finishes the work place measurement procedure, the administrator respectively inputs measured monitoring data according to different fields, and records the inputted data in an EXCEL file provided by the management analysis system. There are multiple field formats established in this EXCEL file in order to adapt the data input of the monitoring data under each kind of occupation. The field formats in the EXCEL file correspond to those in the first database 3. Therefore, the administrator can integrate the monitoring data in the EXCEL file, and saves the monitoring data as EXCEL (*.XLS) files for being imported in the management analysis system.

Second, the management analysis system compares the data format of at least one monitoring data with a normalized format. If the data format does not match the normalized format, an error text message would be generated if the data format does not match the normalized format; otherwise, the data format would be recorded in the first database (step S202). Under such an error detection mechanism, the monitoring data not complying with the normalized format will be filtered and recorded in another error text file for informing the administrator. In this embodiment, only if the data format fully matches the normalized format could it be imported into the management analysis system.

Then, at least one filter instruction is received (step S203).

The management analysis system retrieves the monitoring from the first database according to the at least one filter instruction, and returns at least one monitoring data for further comparison (step S204). In the embodiment, the administrator selects the density data complying with some specific conditions through a filter function in the datasheet. The management analysis system filters unrepeated records in advance for the administrator to select the species to be analyzed from the first database.

Next, the corresponding field data from the second database is then retrieved (step S205). In the embodiment, the management analysis system retrieves the corresponding field data recorded in the second database according to the monitoring data that requires further comparison. The data recorded in the second database represents a sampling information and analysis result of the exposure measurement.

The returned monitoring data and the corresponding field data of the second database are transmitted to a selected statistical model so as to generate at least a readable report (step S206).

According to the description mentioned above, the selected statistical model can be divided into three main models according to different functionalities, including a statistical model, an occupational exposure limit (OEL) model, and a graphic model such that the system administrator can select different models according to different requirements.

In this embodiment, the statistical analysis method can be divided into a statistical method of descriptive statistics, a statistical method of goodness of fit test, and a statistical method of small sample.

The management analysis system can utilize multiple different statistical theories and methods to generate corresponding reports and conclusions. In the embodiment, the statistical theories and methods comprise:

1. The statistical methodology of descriptive statistics for accomplishing the analysis of general descriptive statistics. 2. The statistical methodology of goodness of fit test for accomplishing the distribution testing of data types. 3. The statistical methodology of small sample for accomplishing the normal distribution statistics, and the log-normal distribution statistics.

Except for the abovementioned statistical theories and methods, the management analysis system further substitutes the distribution curve formula according to the variety characteristic and distribution type so as to generate data samples correctly conforming to original data variety. Then the management analysis system obtains the probability percentage of exceeding the tolerance of occupational exposure standard based on the results of the normal distribution statistics and the log-normal distribution statistics. The distribution curve formula is applied to generate data samples with the starting point of exceeding the OEL value and the terminal point of the density distribution curve thereby forming an area under the curve.

Meanwhile, the management analysis system can also utilize sampling dates as a classification condition so as to group density data measured at different times within several days, and to respectively calculate the geometric mean and geometric standard deviation.

According to the calculation of various abovementioned statistical analysis methods, the statistical model generates at least the following readable reports: descriptive statistics, goodness of fit test, normal distribution statistics, log-normal distribution statistics, density distribution curve, density-probability distribution chart, and historical density curve.

Finally, the management analysis system outputs the readable report to the word processing software for display (step S207). In the embodiment, the word processing software is preferably Microsoft EXCEL™ for displaying various exposure analysis reports and charts for the system administrator's reference.

According to the description mentioned above, the method for administrating and analyzing work place monitoring data integrates the data management and data statistics function required by the occupational health management. The user can obtain various exposure analysis reports and charts without utilizing high-level statistical software and being familiar with statistical analysis methods. The overall measurement data analysis report provided by the present invention helps the user to realize the work place condition for further improvement.

Although the present invention has been explained in relation to its preferred embodiment, it is to be understood that many other possible modifications and variations can be made without departing from the spirit and scope of the invention as hereinafter claimed.

What is claimed is:

1. A method for administrating and analyzing work place monitoring data, comprising the steps of:
(A) receiving at least one monitoring data, wherein the at least one monitoring data is obtained from an work place monitoring measurement result;
(B) comparing a data format of the at least one monitoring data with a normalized format and outputting an error text message if the comparison result is not matched, otherwise recording the data format in a first database;
(C) receiving at least one filter instruction;
(D) retrieving the monitoring data from the first database according to the at least one filter instruction and returning at least one monitoring data for further comparison;
(E) retrieving at least one corresponding field data from a second database;
(F) transmitting the returned monitoring data and the corresponding field data of the second database to a selected statistical model so as to generate a selected readable report; and
(G) outputting the selected readable report to word processing software for display.

2. The method for administrating and analyzing work place monitoring data as claimed in claim 1 wherein in step (A), the at least one monitoring data comprises at least a species name, an analysis classification, a sample number, a sampling time, a sampling density and a unit.

3. The method for administrating and analyzing work place monitoring data as claimed in claim 1, wherein in step (A), the at least one monitoring data is recorded by word processing software.

4. The method for administrating and analyzing work place monitoring data as claimed in claim 1, wherein in step (B), the error text message is recorded with the error data of the monitoring data and cannot be recorded in the first database.

5. The method for administrating and analyzing work place monitoring data as claimed in claim 1, wherein in step (D), the filter instruction is the data content to be analyzed.

6. The method for administrating and analyzing work place monitoring data as claimed in claim 1, wherein in step (E), the data stored in the second database is a sampling information and analysis result of the monitoring data.

7. The method for administrating and analyzing work place monitoring data as claimed in claim 6, wherein the second database is an occupational exposure database.

8. The method for administrating and analyzing work place monitoring data as claimed in claim 1, wherein the first database is recorded with at least a unit name, a monitoring date, a work name, a similar exposure group, a chemical name, and a chemical unit.

9. The method for administrating and analyzing work place monitoring data as claimed in claim 1, wherein the selected statistical model comprises a statistical model, an occupational exposure limit (OEL) classification model, and a graphic model.

10. The method for administrating and analyzing work place monitoring data as claimed in claim 1, wherein the selected statistical model further comprises a statistical method of descriptive statistics, a statistical method of goodness of fit test, and a statistical method of small sample.

11. The method for administrating and analyzing work place monitoring data as claimed in claim 1, wherein the readable report comprises at least the descriptive statistics, goodness of fit test, normal distribution statistics, log-normal distribution statistics, density distribution curve, density-probability distribution chart, and historical density curve.
